(19) United States
(12) Patent Application Publication
(10) Pub. No.: US 2007/0210901 A1
(43) Pub. Date: Sep. 13, 2007

(54) Device for Operating a Vehicle

(76) Inventors: Andreas Ahrens, Mannheim (DE); Jorg Jens Hofle, Seeheim-Jugenheim (DE)

Correspondence Address: Joel S Carter;Patent Department, One John Deere Place, Moline, IL, 61265, US

(21) Appl. No.: 10/577,388

(22) PCT Filed: Oct. 7, 2004
(86) PCT No.: PCT/EP04/11188

§ 371 Date: Dec. 22, 2006

(30) Foreign Application Priority Data
Oct. 28, 2003 (DE) 10350407.9

(51) Int. Cl. B60Q 1/00

(52) U.S. Cl. 340/425.5

(57) ABSTRACT

The invention concerns a device for operating a vehicle provided, in particular, in the form of a farming or industrial utility vehicle. The device comprises a grip (12) that can be rigidly mounted on a console of the vehicle. The grip (12) is designed in such a manner that enables it to be at least partially grasped by an operator's hand or is suited for being at least partially reached into by an operator's hand. The grip (12) comprises operational controls (18, 20, 22), with which at leas one function of the vehicle and/or one function of an implement that can be optionally adapted to the vehicle can be controlled. The aim of the invention is to resolve ergonometric problems during operation. To this end, a display unit (24) assigned to the grip (12) is provided that can be mounted in a manner that permits it to be displaced relative to the grip (12).

The invention concerns a device for operating a vehicle, which is, in particular, built in the form of an agricultural or industrial utility vehicle.

Devices of the type mentioned above are built in many different ways and have been known for a long time from the state of the art. Thus, operating devices are known that are built merely in the form of switches or levers, which are located either on a console of a vehicle cabin or on an armrest of an operator's seat. Furthermore, for example, a joystick is used, for example, to control an agricultural utility vehicle, with which either a gear function of the vehicle, in connection with a motor rpm or a work implement attached to the vehicle, for example, a front loader, can be controlled. Such a joystick usually comprises an operating element, which, for example, is made in the form of a push-button, with which an additional function either of the vehicle or of the work implement attached to the vehicle can be controlled.

Meanwhile, modern agricultural utility vehicles also comprise, display units, that are built, for example, as LCD (liquid crystal device) displays. Information regarding the operating state of the vehicle, for example, is displayed on these display units—for example, regarding its speed, the current prevailing engine rpm and the switching state of the gears. Also, information regarding the operating state and the load of a power take-off shaft (PTO) of the vehicle can be shown. Often, operating elements are located directly on the display units, so that in this way, a spatial and functional connection exists between what is shown on the display unit and the operating elements.

However, the optimal distance for the gripping or operating of an operation element is different from the optimal distance of the display unit to the eyes of the operator. This fact is, in this respect, an ergonomic problem. If the spatial position of the display unit can be changed, the positions of the operating elements also change accordingly, so that the ergonomic problem is not solvable by a changeable arrangement alone.

The objective of the invention under consideration, therefore, is to indicate and refine a device of the type mentioned initially, by means of which the aforementioned problems are overcome. In particular, the display unit should have an optimal distance to the eyes and the operating elements, as well as an optimal actuation distance for an operator.

The objective is achieved, in accordance with the invention, by the teaching of claim 1. Other advantageous developments and refinements of the invention can be deduced from the subordinate claims.

In accordance with the invention, a device of the type mentioned in the beginning comprises a gripping part, which can be placed rigidly on a console of the vehicle. The gripping part is made such that it can be gripped, at least in part, by one hand of an operator or such that it is suitable, at least in part, for engagement with one hand of an operator. The gripping part has operating elements with which at least one function of the vehicle and/or one function of a work implement, which perhaps can be attached to the vehicle, can be controlled. A display unit correlated with the gripping part is provided, and can be placed in an adjustable manner relative to the gripping part.

In accordance with the invention, it was recognized, first of all, that particularly with commercial or industrial utility vehicles, a development of the gripping part, which can be, at least in part, gripped by and/or which can engage with an operator's hand, is advantageous, since, in this way, a defined distance exists between the operator and the gripping part with a hand of the operator gripping the gripping part. This distance can, for example, be selected by adjusting the sitting position of the operator such that it is optimal from an ergonomic perspective.

For the adjustment of an optimal distance between the eyes of an operator and the display unit, the display unit is correlated adjustably, relative to the gripping part. In this regard, “correlated” is understood such that an operation of the operating elements of the gripping part can bring about, directly or indirectly, a change in what is shown on the display unit—that is, for example, by an electronic coupling. In this respect, it may be a spatial and/or a functional correlation of the gripping part to the display unit.

A rigid affixing of the gripping part is particularly advantageous with agricultural or industrial utility vehicles, since such vehicles are often driven on terrain with, to some extent, considerable ground unevenness and the operator of the vehicle is exposed to corresponding movement. The operator can hereby grip the gripping part with his hand and/or intervene therein, wherein not only is there a hand contact surface in the traditional sense, but a fixing of the operator's hand on the gripping part is also possible during the operation, although the operator can perhaps move, relative to the gripping part, for example, as a result of a spring-supported seat, relative to the vehicle cabin. Since the gripping part is located rigidly on the console in accordance with the invention under consideration, and since the gripping part does not have joystick functionality, incorrect operation of the vehicle is also not caused hereby.

In a preferred embodiment, the display unit has a monitor. This monitor could, for example, be made as an LCD or as a TFT (thin film translator) monitor and could make available a monochrome or polychrome representation. Preferably, information regarding the operating state of the vehicle or of a work implement is shown with the monitor; the operating state is attached to the vehicle. In addition, the monitor could also show a sequence of images recorded with a camera. Such a solution is conceivable, for example, if a camera is located at the rear of a vehicle or a tractor, which records a coupling process between the tractor and a work implement. The sequence of images could be shown in only one monitor section. The monitor could have a touch-entry capability, as is known, for example, from so-called touch screens. An antireflective coating could be provided on the monitor, which prevents, at least to a large extent, the reflection of sunlight and thus the blinding of the operator.

At least for infrequently needed functions, it may be appropriate to provide at least one more operating element on the display unit. These elements could be, for example, operating elements with which the brightness and/or the contrast of the display unit can be adjusted. Such operating elements could be placed laterally on the frame of the display unit or on its back side.

In a preferred embodiment, the adjustment of the display unit takes place relative to the gripping part in that the display unit is swiveled and/or turned, relative to the gripping part. Accordingly, the display unit is placed so it can turn and/or swivel correspondingly. Preferably, an adjustment of the display unit, relative to the gripping part, takes place manually and is carried out by the operator.

The display unit could then be swiveled and/or turned such that a display area of the display unit used to show information to the operator, for example, the LCD monitor, is always essentially facing the operator. Here, one can assume that the operator does not significantly change his sitting position in the vehicle seat. However, the case may also occur that the operator looks through the rear cabin window for certain tasks, for example, the coupling of a work implement with an agricultural commercial vehicle or with a tractor, and for this, perhaps turns the vehicle seat relative to the vehicle cabin or to the vehicle frame. For such a case, the display unit could also be located so that it could swivel and/or turn also, such that it could always be viewed directly by the operator, for example, from a position located in the vehicle cabin in the front and laterally to a position located in the vehicle cabin in the rear and laterally.

Basically, provision is made to support or to place the display unit such that the spatial alignment or the orientation of the display unit can be essentially retained. This applies both for a swiveling or turning of the display unit relative to the gripping part, which is carried out manually by the operator himself and also carried out automatically.

In a preferred embodiment, the display unit can be locked in a position prespecified by the operator. This could be attained, on the one hand, in that the adjustment characteristics of the display unit are difficult enough to disturb so that even strong movements of the vehicle are not sufficient to alter the display unit as a result of inertia forces. On the other hand, locking levers could be provided also, which lock the display unit in a position selected by the operator, for example, by a force-locking clamping in accordance with provided hinges.

In a very especially preferred embodiment, the display unit can be connected to the gripping part or with the console of the vehicle via a movement arm. The movement arm could have an elongated form. Very especially preferred, the movement arm is placed, articulated, on the one hand, on the gripping part and, on the other hand, on the display unit. The movement arm could, however, also be placed, articulated, on the one hand, on the console of the vehicle and, on the other hand, on the display unit. The provision of the movement arm primarily results in the display unit being swivelable, relative to the gripping part or to the console of the vehicle. The movement arm could perhaps be made so that it can be telescoped.

Preferably, a connection with rotating articulation characteristic is provided between the movement arm and the gripping part or the console, so that the movement arm can rotate around a rotating axis. Between the display unit and the movement arm, a connection with ball articulation characteristics could be provided. In this respect, a swiveling of the display unit located on the movement arm is possible relative to the gripping part or the console by a rotating articulation between the movement arm and the gripping part or the console. By providing a ball articulation between the movement arm and the display unit, it is possible to change the spatial orientation of the display unit with a prespecified position of the movement arm, so that, for example, the TFT Monitor of the display unit can be oriented toward the operator—within specifiable limits. Basically, connecting lines for the connection or for the electrical supply of the display unit are provided with the gripping part or with vehicle electronics, and are located in the movement arm. Preferably, the connecting lines are constructed with flexible cables or with a flexible cable harness, which is/are conducted through articulations, which may be provided between the display unit, movement arm, gripping part, or console. Alternatively, or additionally, sliding contacts could also be used with any articulations provided.

In a very especially preferred embodiment, the gripping part has an area that is constructed in an essentially cylindrical shape and that can be gripped at least in part by one of the operator's hands. Therefore, this is a specification of the spatial shape or the extent of the area of the gripping part, which is gripped at least in part by the operator's hand. Preferably, the operating elements are placed on the cylindrical area such that they can be actuated by the thumb of one of the hands of the operator. In this way, an ergonomic operation or actuation of the operating parts located on the gripping part is possible if the operator's hand grips, at least in part, the cylindrical area.

The gripping part could have a recess or a frame, which one hand of the operator can engage, at least in part. The frame preferably embraces an essentially cylindrical area, which can be gripped at least in part by the operator's hand.

Basically all operating elements known from the state of the art can be used as operating elements of the gripping part. Preferably, operating elements constructed in the shape of a rotating knob, a change-over switch and/or a push-button, are used for the gripping part. The rotating knob, in particular, is provided so as to actuate an incremental transducer correspondingly, which in this way, produces an electrical signal that is dependent on the rotation of the rotating knob. Very especially preferred, the operating elements of the gripping part are used so as to control a menu shown on the display unit. Accordingly, the operating elements of the gripping part have a function comparable to a computer mouse or a keyboard, for example, scrolling—that is, up or down sheets—of an image section or the selection of a menu point. The operating elements could also be made so they are programmable—that is, the operator can, in a corresponding programming mode, lay on an operating element individual functions for controlling a work implement (short-cut function).

So that a remote operation of the device in accordance with the invention is possible, provision could be made so that the gripping part is constructed such that a part of it is constructed in a detachable manner. The detachable part has at least one operating element. In other words, the gripping part is constructed in at least two parts and all operating elements could be placed on the detachable part. By removing the detachable part from the gripping part, the device in accordance with the invention can also be operated without problems if, for example, the operator in the vehicle cabin is in a sitting position, in which the gripping part constructed as one part cannot readily be operated or can be operated in an uncomfortable manner. The detachable part can be connected to the device in accordance with the invention via a cable connection or via a radio communication, in particular, in a detached state. If the detachable part is affixed to the gripping part, an electrical connection could be set up between the operating elements and the device in accordance with the invention by electrical contact connections, which on the one hand are provided on the gripping part, and on the other hand on the detachable part. The detachable part could be locked onto the gripping part by means of a latching, snapping, or clamping connection.

Basically, the console, on which the gripping part is rigidly fixed, could be fixed stationarily relative to a vehicle frame, for example, on a rail of a vehicle cabin. Alternatively, the console could be fixed stationarily relative to an operator's seat of the vehicle, for example, on an armrest of the operator's seat. In this case, the gripping part likewise carries out, with the seat, a relative movement with respect to a vehicle frame, in particular, if the seat is fixed in an elastic manner and the vehicle moves over uneven terrain. Even in the turning of the seat, the gripping part also turns in this mode of arrangement. In a very especially preferred embodiment, the device in accordance with the invention has an ISO display functionality in accordance with the 11783 specification. Here, particular provision is made so that an information exchange takes place via a CAN bus. In this way, it is possible to make available a standardized interface for work implements of different manufacturers. Thus, for example, provision is made so that a manufacturer of a work implement makes available a corresponding software, with which, for example, information regarding the instantaneous operating state of the work device can be shown on the display unit. Alternatively or additionally, the work device could be controlled with the aid of a menu guide, which can be selected via the operating elements.

Thus, in a very especially advantageous manner, it is no longer necessary, for example, in a tractor, to provide a large number of operating elements only for controlling various work devices. Rather, all work devices that make available a corresponding interface are adapted to a tractor and in a particularly advantageous manner are controlled with the device in accordance with the invention.

There are various possibilities for advantageously developing and refining the teaching of the invention under consideration manner. In this respect, reference is made, on the one hand, to the patent claims that follow claim 1 and, on the other hand, to the explanation of preferred embodiment examples of the invention below, with the aid of the drawings. In connection with the explanation of the preferred embodiment examples of the invention with the aid of the drawing, generally preferred developments and refinements of the teaching are also explained. In the drawing, the figures show the following, in a schematic representation:

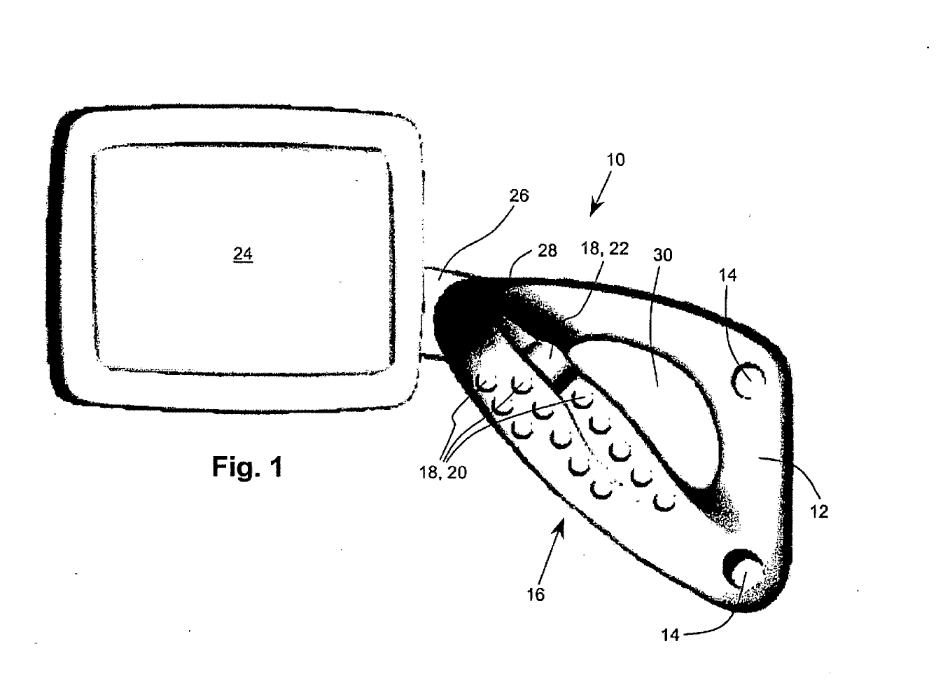

FIG. 1, a perspective view of an embodiment example, according to the invention under consideration; and

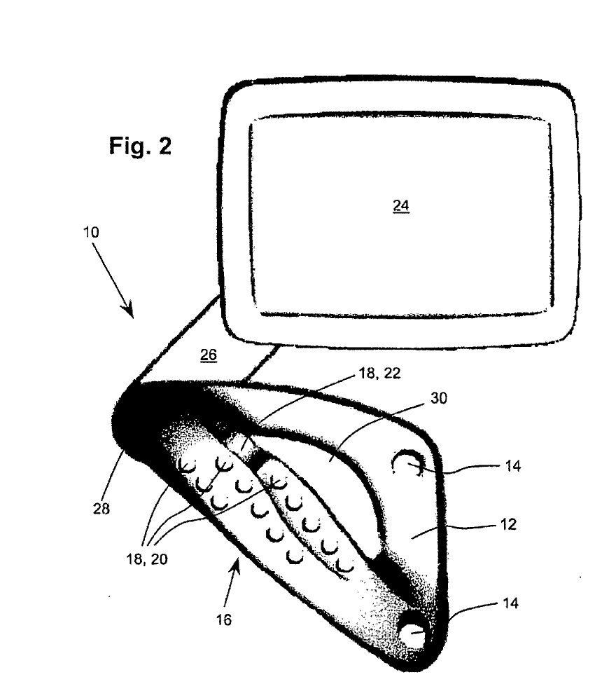

FIG. 2, a perspective view of the embodiment example according to FIG. 1, wherein the display unit from FIG. 2 has another position relative to the gripping part—in comparison to FIG. 1.

The same or similar components are marked with the same reference symbols in the figures. FIGS. 1 and 2 show a device 10 to control a work device not shown in FIGS. 1 and 2 and adaptable to a vehicle. The device 10 could, however, also be used to control the vehicle itself.

The device comprises a gripping part 12, which can be affixed to affixing sites 14, which are referenced merely schematically, on a rail of a vehicle cabin not shown in FIGS. 1 and 2. The gripping part 12 comprises an area 16, which can be gripped almost completely by the operator's hand. The gripping part 12 has operating elements 18 with which different functions of the work device attached to the vehicle can be controlled. The operating elements 20 are made in the shape of punch-buttons. The operating element 22 is a rotating knob for an incremental transducer, which is located in the gripping part 12 and therefore not shown in FIGS. 1 and 2. The device in accordance with the invention comprises a display unit 24, which is made in the form of a TFT monitor. Information regarding the load and the operating state of the work device attached to the vehicle can be shown on this monitor. The display unit 24 is placed so that it can be swiveled and also rotated relative to the gripping part 12. A movement arm 26 is provided, which correlates the display unit 24 with the gripping part 12 spatially and with which the display unit 24 can be positioned relative to the gripping part 12. The movement arm 26 is placed on the gripping part 12 so that it can rotate around the rotating hinge axis 28, placed essentially perpendicular to the plane of the figure in this representation. On the other hand, the movement arm 26 is connected to the display unit 24 on the back side of the display unit 24—in approximately the middle—via a ball articulation. As the result of the rotating hinge connection between the gripping part 12 and the movement arm 26, the movement arm 26 can rotate or swivel around the rotating hinge axis 28 in a plane that essentially contains the middle axis of the area 16 and is situated perpendicular to the rotating hinge axis 28. As a result of the ball articulation between the movement arm 26 and the display unit 24, it is possible to align the TFT monitor of the display unit 24 such that it can be viewed by an operator directly and comfortably. FIG. 1 shows the device 10 in accordance with the invention in a state in which the display unit 24 is located to the left of the gripping part. FIG. 2 shows the device 10 in accordance with the invention in a state in which the display unit 24 is located relatively far to the right and above the gripping part 12. Both in the state according to FIG. 1 and also in the state according to FIG. 2, the display unit 24 is located such that the long sides of the TFT monitor are situated essentially horizontal.

The gripping part 12 has a frame construction, which forms a recess 30. An operator of the vehicle or of the work device can at least partially reach into this recess with his hand and grip at least to a large extent the area 16 of the gripping part 12 with his fingers. The operating elements 18, 20, and 22 are placed such that they can be reached effortlessly in this state by the hand of the operator and, in particular, can be actuated by the thumb of this hand.

Finally, very special reference is made to the fact that the embodiment examples discussed in the preceding are used merely to describe the claimed teaching, but that the teaching is not limited to the embodiment examples.

1. Device for the operation of a vehicle, which, in particular, is constructed in the form of an agricultural or industrial utility vehicle, with a gripping part (12), which can be placed rigidly on a vehicle console, wherein the gripping part (12) is constructed such that it can be gripped at least in part by one of the operator's hands, and/or that it is suitable at least in part for engagement with an operator's hand, wherein the gripping part (12) has operating elements (18, 20, 22), with which at least one function of the vehicle and/or one function of a work device, that may be attached to the vehicle, can be controlled, and wherein a display unit (24) is provided that is correlated to the gripping part (12) and can be arranged so that it is adjustable, relative to the gripping part (12).

2. Device according to claim 1, wherein the display unit (24) has a monitor, preferably, an LCD or a TFT monitor, wherein the monitor can show information regarding the operating state of the vehicle or a work device that can be attached to the vehicle and that, preferably, has a touch-entry capability comparable to a touch screen.

3. Device according to claim 1 or 2, wherein at least one other operating element is provided on the display unit (24).

4. Device according to one of claims 1 to 3, wherein the display unit 24 is situated so that it can swivel and/or rotate relative to the gripping part (12).

5. Device according to claim 4, wherein the display unit (24) can swivel and/or rotate such that a display area of the display unit (24), which is used to show information to the operator, always essentially faces the operator or can always be viewed directly by the operator and/or that the orientation of the display unit (24) can essentially be retained.

6. Device according to one of claims 1 to 5, wherein the display unit (24) can be locked in a position specified by an operator.

7. Device according to one of claims 1 to 6, wherein the display unit (24) can be connected to the gripping part (12) or to the vehicle console via a movement arm (26), which is preferably located, articulated, on the gripping part (12) or on the console of the vehicle and/or, alternatively, on the display unit (24).

8. Device according to claim 7, wherein a connection with rotating hinge characteristics is provided between the movement arm (26) and the gripping part (12) or the console, and/or a connection with ball articulation characteristics is provided between the display unit (24) and the movement arm (26).

9. Device according to claims 7 or 8, wherein connecting lines for the connection of the display unit (24) to the gripping part (12) or to vehicle electronics are provided, and are located in the movement arm (26).

10. Device according to one of claims 1 to 9, wherein the gripping part (12) has an essentially cylindrical area (16) that can be gripped at least in part by an operator's hand, wherein the operating elements (18, 20, 22) are preferably located on the cylindrical area (16) such that they can be actuated with the thumb of one of the operator's hands, if the hand grips at least in part the cylindrical area (16).

11. Device according to one of claims 1 to 10, wherein the gripping part (12) has a recess (30) or a frame, in which an operator's hand can reach in at least partially, wherein the frame preferably has an essentially cylindrical area (16) according to claim 9.

12. Device according to one of claims 1 to 11, wherein an operating element (18, 20, 22) of the gripping part (12) is shaped in the form of a—preferably provided for an incremental transducer—rotating knob, a change-over switch, and/or a push-button, wherein the operating elements (18, 20, 22) are provided, in particular, for the control of a menu, which can be shown on the display unit (24).

13. Device according to one of claims 1 to 12, wherein the gripping part (12) is constructed such that a part of it is made to be detachable, wherein the detachable part has at least one operating element (18, 20, 22).

14. Device according to claim 13, wherein the detachable part can be connected to the device via a cable connection or via a radio communication, wherein an operation at a distance from the device is possible.

15. Device according to one of claims 1 to 14, wherein the console is situated stationary relative to a vehicle frame or stationary relative to an operator's seat.

16. Device according to one of claims 1 to 15, which has an ISO display functionality, according to the 11783 specification, wherein an information exchange preferably takes place via a CAN bus.
